(19) United States
(12) Patent Application Publication
(10) Pub. No.: US 2010/0027685 A1
(43) Pub. Date: Feb. 4, 2010

(54) METHOD OF PROCESSING BOUNDARY STRENGTH BY DEBLOCKING FILTER AND CODING APPARATUS

(75) Inventors: Han-Sang KIM, Suwon-si (KR); Young-Hun Joo, Yongin-si (KR); Kwang-Pyo Choi, Anyang-si (KR); Hyung-Ho Chae, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/512,353

(22) Filed: Jul. 30, 2009

(30) Foreign Application Priority Data
Jul. 30, 2008 (KR) 10-2008-0074389

(51) Int. Cl. H04N 7/12

(52) U.S. Cl. 375/240.29; 375/E07.027

(57) ABSTRACT

Provided is a method and apparatus for processing a boundary strength (BS) by a deblocking filter, the method including: an encoding process for generating a packet including BS information; and a decoding process for receiving the packet including the BS information generated from the encoding process, and during the decoding process the BS information is used in a deblocking process.

### CROSS-REFERENCE TO RELATED PATENT APPLICATION

This application claims priority from Korean Patent Application No. 10-2008-74389, filed on Jul. 30, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to multimedia coding, and more particularly, to processing a boundary strength by a deblocking filter.

2. Description of the Related Art

Multimedia video coding in the related art causes blocking edges by performing a discrete cosine transform (DCT) of blocks or motion compensation. The blocking edges cause latticed lines on the entire video, and thereby may be one of the factors that deteriorates the qualitative state of the video to be provided a user.

A method of removing a boundary strength (BS) by using a deblocking filter can alleviate the blocking edges, which is shown in FIG. 1, as a graph for illustrating the respective ratios required for computation in a coding process. However, as shown in FIG. 1, in the computation constituting the coding process, the computation of a deblocking filter occupies 38% of the graph, in which a computation for outputting a vertical BS and a horizontal BS for determining a BS value occupies about 20% of the computation of deblocking filter.

FIG. 2 is a flow chart for determining a BS according to the related art, and particularly, for determining a BS value for an h.264 deblocking filter. Referring to FIG. 2, it can be seen that a process for determining a BS value is carried out by complicated calculations of characteristic values (intra coded, cbp, reference frame, motion vector) of neighboring blocks, such as loading, comparison, bit and, an absolute value (ABS), logical sum (or).

Moreover, FIGS. 3A and 3B, illustrating a view of a macro block, schematically illustrates the calculation of vertical/horizontal BSs over 4×4 blocks, in which the dotted lines indicate vertical edges 192 and 193 and horizontal edges 194 and 195. Referring to FIGS. 3A and 3B, since all BSs of vertical and horizontal boundaries between blocks 191 have to be computed, it can be understood that in a deblocking filter, the computational loads is highly occupied in an entire macro block.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. In particular, the present invention provides a deblocking filter capable of minimizing computational loads of boundary strengths.

In accordance with an aspect of the present invention, there is provided a method for processing a boundary strength (BS) by a deblocking filter, wherein a packet including BS information, generated from an encoding process, is utilized by a decoding process.

In accordance with another aspect of the present invention, there is provided a coding apparatus, the apparatus including: an encoding unit for generating a packet including BS information; and a decoding unit for decoding the information packet generated by the encoding unit.

### BRIEF DESCRIPTION OF THE DRAWINGS

The above and/or other aspects of the present invention will be more apparent by describing in detail exemplary embodiments thereof with reference to the attached drawings in which:

FIG. 1 is a graph for illustrating computational loads in a h.264 decoder of the related art;

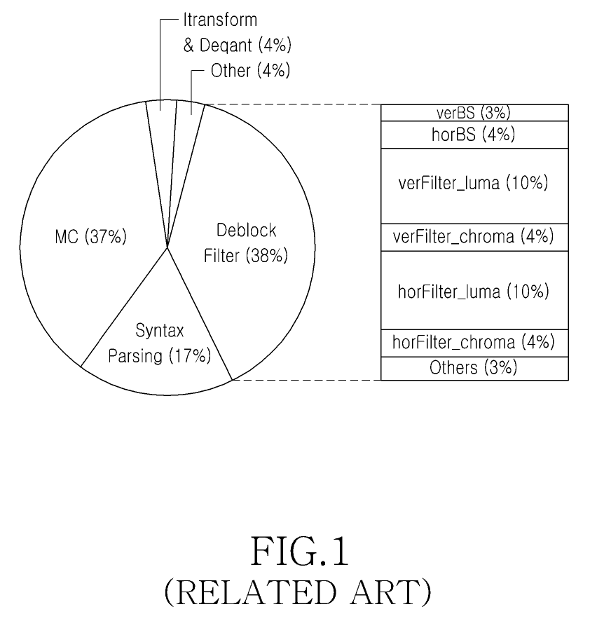

FIG. 2 is a flow chart for determining a boundary strength according to the related art;

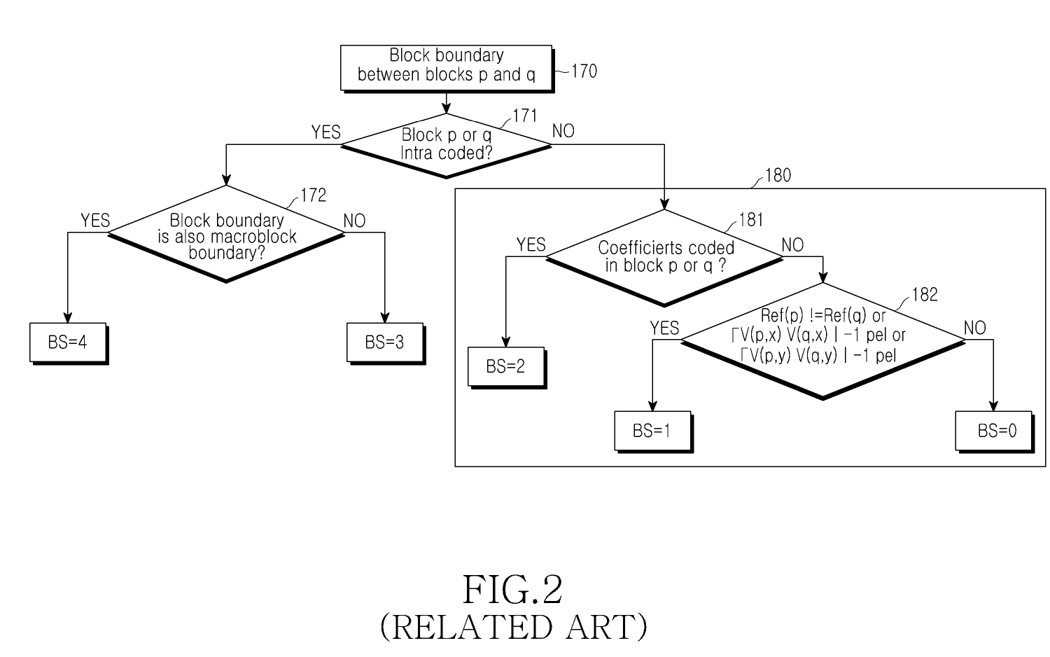

FIGS. 3A and 3B illustrate boundary regions of a macro block, which is an object of a deblocking filter;

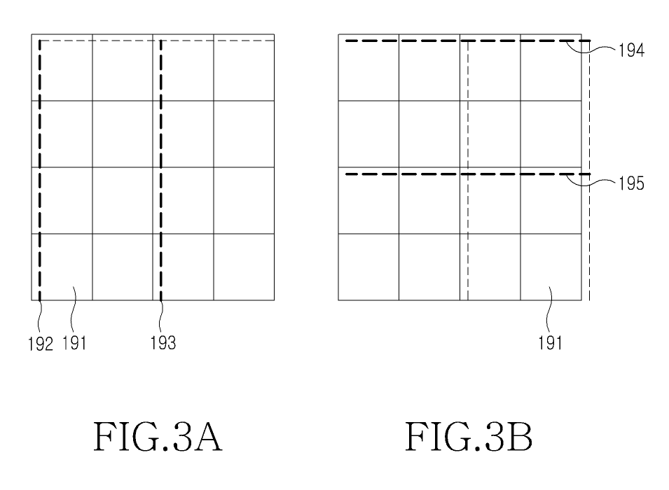

FIG. 4 schematically illustrates a coding apparatus according to an exemplary embodiment of the present invention;

FIG. 5 illustrates one packet structure including information of a boundary strength, according to an exemplary embodiment of the present invention;

FIG. 6 illustrates another packet structure including information of a boundary strength, according to an exemplary embodiment of the present invention;

FIG. 7A illustrates an example of value of BS indicated to each unit of QCIF image, and FIG. 7B illustrates an example of the packet structure as shown in FIG. 5;

FIG. 8A illustrates an example of rotation operation according to the exemplary embodiment of the present invention, and FIG. 8B illustrates an example of the packet structure as shown in FIG. 6;

FIG. 9 is a flow chart for analyzing the packet including information of a boundary strength in a decoder, according to an exemplary embodiment of the present invention; and

FIG. 10 illustrates an example of the packet as shown in FIG. 5.

### DETAILED DESCRIPTION OF THE EXEMPLARY EMBODIMENTS

Hereinafter, exemplary embodiments of the present invention will be described in detail with reference to the accompanying drawings. In the following description of the present invention, a detailed description of known functions and configurations incorporated herein is omitted to avoid making the subject matter of the present invention unclear.

In a method of processing a boundary strength (BS) by a deblocking filter, according to the present invention, a packet including BS information generated by an encoding process is provided to a decoding process, and thereby a computation process on a BS may be omitted in the decoding process. Accordingly, the BS processing method by the deblocking filter, according to the present invention, may minimize computational loads.

In other words, the present invention is advantageous in that it can minimize computational loads while maintaining information volume, because in BS processing by a deblocking filter, a packet including BS information generated by an encoding process is analyzed and then is applied to BS processing during a decoding process.

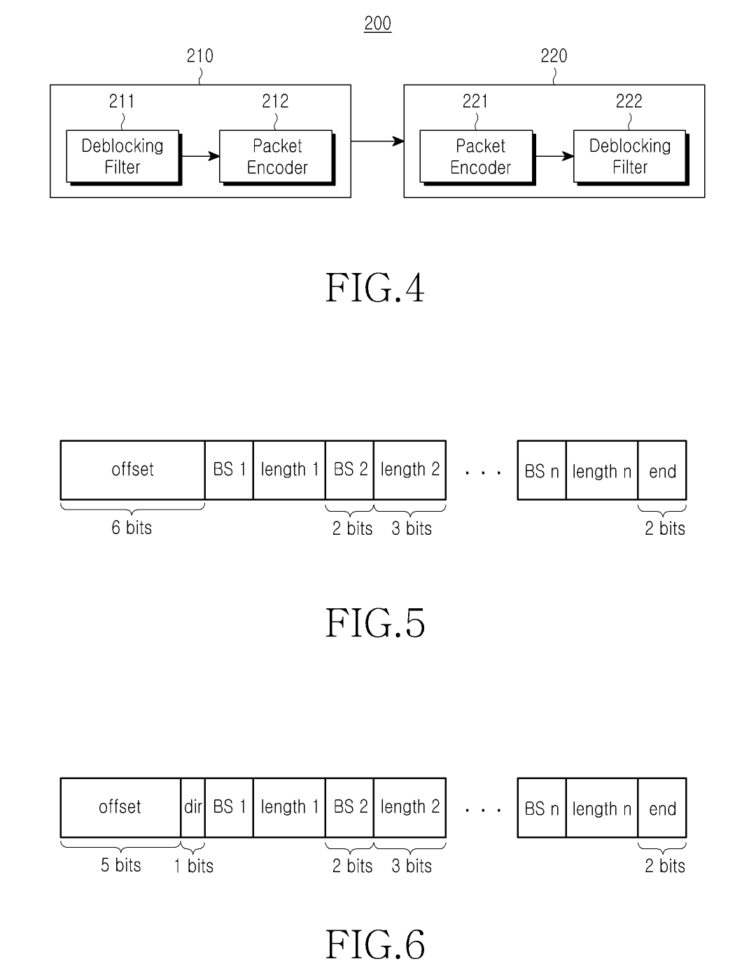

FIG. 4 schematically illustrates a coding apparatus according to an exemplary embodiment of the present invention. Referring to FIG. 4, a coding apparatus 200 includes an encoding unit 210 for generating a packet including BS information, and a decoding unit 220 for decoding the packet generated from the encoding unit 210.

The encoding unit 210 includes a deblocking filter 211 for generating BS information, and a packet encoder 212 for generating a packet including the BS information generated from the deblocking filter 211.

The decoding unit 220 includes a packet decoder 221 for decoding the packet including the BS information, provided from the packet encoder 212, and a deblocking filter 222 for controlling the block distortion of a bitstream provided from the encoding unit 210 based on the BS information decoded in the packet decoder 221.

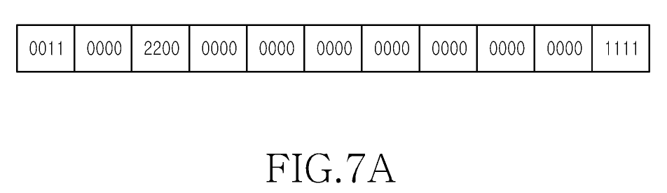

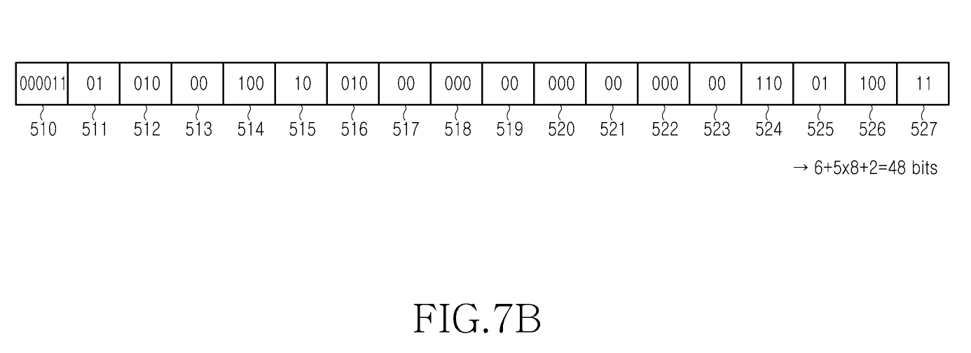

A packet structure (BS_IP) including BS information, which is applicable to a coding apparatus and method according to the present invention, may be largely divided into two exemplary packet structures depending on whether a ‘dir’ field is applied or not. FIG. 5 illustrates one example of a packet structure including BS information in which a ‘dir’ field is not applied. FIG. 6 illustrates another example of a packet structure including BS information according in which the ‘dir’ field is applied. In other words, both FIGS. 5 and 6 illustrate a packet structure including BS information applicable to the present invention, and the difference between them depends on whether the ‘dir’ field is included or not.

The parameter and bit allocation of a packet including BS information according to an exemplary embodiment of the present invention may be defined in Tables 3 to 6.

TABLE 3

Offset_max
(6~8 bits)

| | bits | dec |
|---|---|---|
| QCIF | 101100 | 44 |
| QVGA | 1010000 | 80 |
| CIF | 1011000 | 88 |
| VGA | 10100000 | 160 |

In Table 3, Quarter Common Intermediate Format (QCIF), Quarter Video Graphics Array (QVGA), Common Intermediate Format (CIF), and Video Graphics Array (VGA) are standards indicating the resolution of a monitor, and their resolutions may be defined as 176×144, 320×240, 640×480, and 704×576, respectively.

TABLE 4

| | Dir (1 bit) |
|---|---|
| 0 | left -> right |
| | top -> bottom |
| 1 | right -> left |
| | bottom -> top |

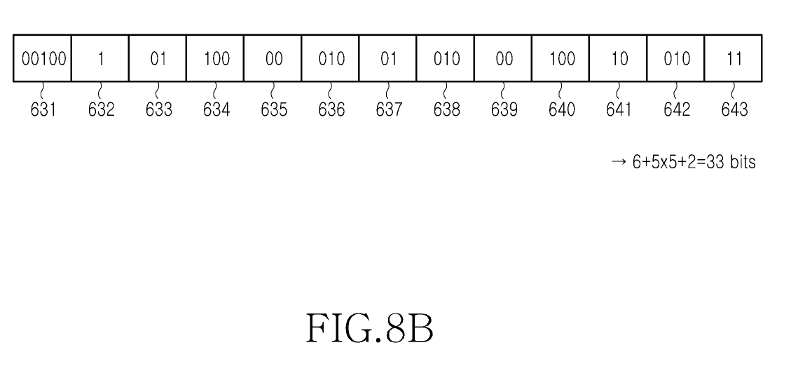

As noted in Table 4, the dir field is allocated 1 bit. When the dir field is set to 0, a BS is set stepwise by offset calculation from left to right, or from top to bottom. Also, when the dir field is set to 1, offset calculation is performed from right to left, or from bottom to top, and as shown in FIG. 8, a BS is set stepwise (or cyclically) from an offset position. Herein, the field indicating an offset value is reduced by 1 bit. The total length of an offset field and a dir field, in a packet including the dir field, is the same as the length of an offset field of another packet not including the dir field, but can minimize the entire length of BS information.

TABLE 5

| | BS (2 bits) |
|---|---|
| 0 | 0 |
| 1 | 1 |
| 10 | 2 |
| 11 | end |

The BS field may be represented by 2 bits, as shown in Table 5. A BS can be set as a value from 0 to 4, but 3 or 4 is determined according to whether a current macro block is intra-coded or not. Thus, in a packet, the case where a BS is actually 3 or 4 is ignored, and only BSs of 0 to 2 are considered.

In other words, a BS value of 0 may be represented by a bitstream of 00, 1 may be represented by a bitstream of 01, and 2 may be represented by a bitstream of 10. Also, a bitstream of 11 corresponds to the case where a BS value of 0 is maintained up to the end of a current column or row (in a horizontal or vertical direction), and may be set as an indicator field indicating the end of a packet. However, the first two bits of an offset have to be different from 11 indicating the end of a packet.

TABLE 6

| | Length (3 bits) |
|---|---|
| 0 | 8(2³) |
| 1 | 1 |
| 10 | 2 |
| 11 | 3 |
| 100 | 4 |
| 101 | 5 |
| 110 | 6 |
| 111 | 7(2³ − 1) |

The length field as noted in Table 6 indicates the length where a BS is successively maintained. In Table 6, the length field is assumed to be 3 bits. A length field including 2 units (8 pixels) may be represented by a bitstream of 010, and bitstreams including only ‘0’ are understood as 2̂(the number of bits in a length field).

The packet (including BS information) as shown in FIGS. 5 and 6 may include an offset field, a BS field, a length field, and an end field, and the BS field and the length field may alternate with each other up to the end field of the packet.

The offset field indicates an interval from the leftmost end (in a horizontal direction) and the uppermost end (in a vertical direction) of a video until a BS has a value other than 0. Herein, 4 pixels with a BS value are set as one unit. Accordingly, a CIF video of 352×288 resolution may be expressed in a maximum of 7 bits, as 88×72 (0×58×0×48), when 4 pixels are set as one unit.

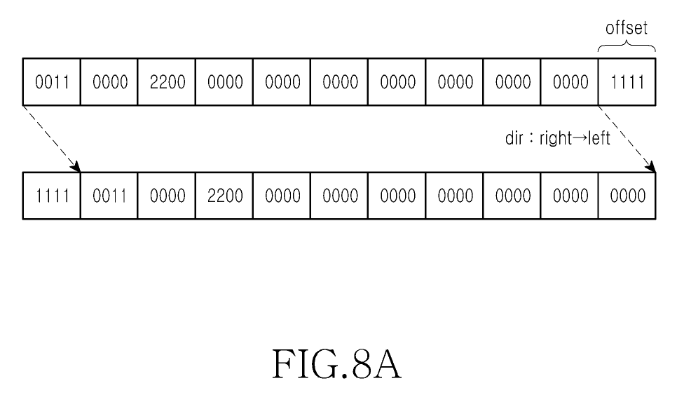

FIG. 7A illustrates an example of value of BS indicated to each unit of QCIF image, and FIG. 7B illustrates an example of the packet structure as shown in FIG. 5. The packet as shown in FIG. 7B includes an offset field 510, BS fields 511, 513, 515, 517, 519, 521, 523, and 525, length fields 512, 514, 516, 518, 520, 522, 524 and 526, and an end field 527.

The packet may include a total of 48 bits containing 6 bits for the offset field 510, 40 bits (5 bits per field) for the BS fields 511, 513, 515, 517, 519, 521, 523 and 525 and the length fields 512, 514, 516, 518, 520, 522, 524 and 526, and 2 bits for the end field 527.

FIG. 8A illustrates an example of rotation operation according to the exemplary embodiment of the present invention, and FIG. 8B illustrates an example of the packet structure as shown in FIG. 6. Meanwhile, the packet as shown in FIG. 8B, according to an example (including a dir field) of the packet structure as shown in FIG. 6, includes an offset field 631, a dir field 632, BS fields 633, 635, 637, 639, and 641, length fields 634, 636, 638, 640 and 642, and an end field 643. By rotating the last 4 units (one unit corresponds to 4 pixels) in order to arrange a section including many successive BSs of 0 to the last position, the packet structure can be simplified as “1111, 0011, 0000, 1100, 0000˜0000”, as shown in FIG. 8A. Since the offset is set from right to left, the dir field may be 1 of bit length (see Table 2), and the offset may be represented by a bitstream of 00100. The total length of a packet including BS information used for this is 33 bits, and thus it can be seen that the computational loads are reduced by about 30% compared to the example shown in FIG. 5.

In comparison with FIGS. 7B and 8B, such efficiency can be confirmed. In other words, when BSs of a total of 44 units are set as shown in FIG. 7B in QCIF video, the BS information includes a total of 48 bits containing 6 bits for the offset field, 8 couples of BS and length fields (5 bits per field), and 2 bits for the end field indicating the end. Meanwhile, in an expression using a dir field as shown in FIG. 8B, in order to arrange a section including many successive BSs of 0 to the last position, by rotating the last 4 units, the packet structure can be simplified as ‘1111 0011 0000 11 0 . . . ’. Accordingly, since the offset value is set from right to left, the dir field may be 1 of bit length, and the offset may be represented by a bitstream of 00100. The total length of BS information used for this is 33 bits, and thus it can be seen that the computational loads are reduced by about 30% compared to the case where a dir field is not included.

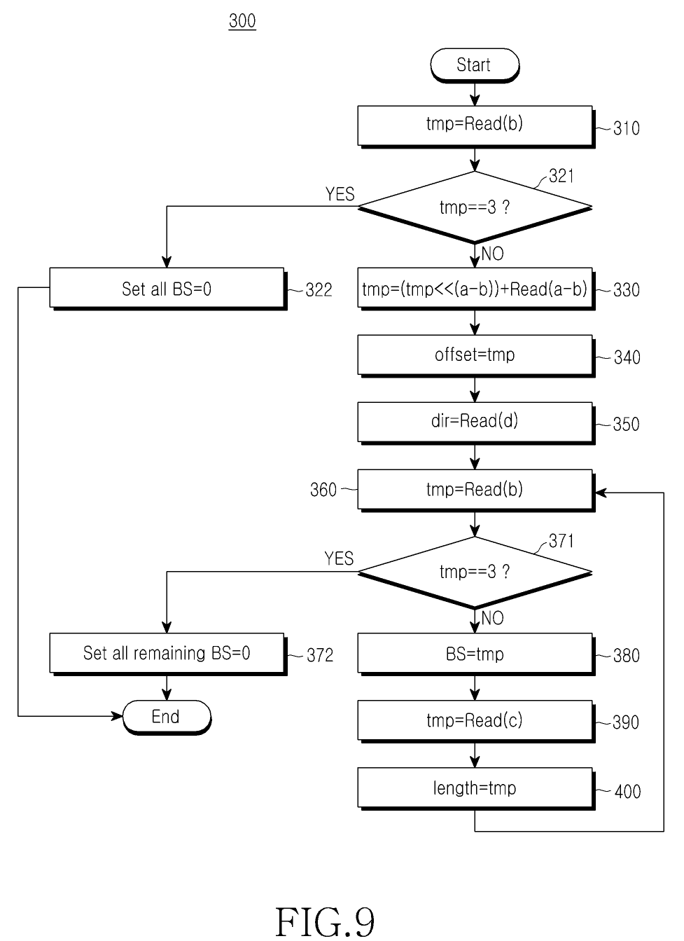

FIG. 9 is a flow chart for analyzing the packet including BS information in a decoder, and is for illustrating a decoding process of bit-allocated fields as noted in Table 5. Referring to FIG. 9, the decoder reads bits indicating BS value in step 310, and determines whether the read bits is 3 in a step 321. If the read bits is 3, the decoder proceeds to step 322 to set all BS value as ‘0’, and terminates the operation. If the read bits is not 3, the decoder proceeds to step 330 to read bits indicating offset value, and to store the read bit to offset value. The decode reads bit indicating dir value in step 350 and then stores the read bit as dir value. The decoder read bits indicating bits indicating BS Value in a step 360, and then determines whether the read bits is 3 in a step 371. If the read bits is 3, the decoder proceeds to step 372 to set all remaining BS value as ‘0’, and terminates the operation. If the read bits is not 3, the decoder proceeds to step 380 to store read bits as BS value. The decoder reads bits indicating length value in step 390 and stores read bits as a length value in step 400, and then proceeds to step 360. A dir field operation 350 is performed only when a packet including a dir field is provided, and the function of Read(x) indicates a value of the read ‘x’ bit(s) in a packet including BS information. In other words, if a packet is set as ‘11’, all BS values are 0. The analysis is performed in order of the offset (dir) field, a BS field 1, a length field 1, a BS field 2, a length field 2˜a BS field n, and a length field n, and then when a field with a BS value of 3 is found, all BSs of rows or columns after the field are 0.

TABLE 7

| | Offset | | Boundary | |
|---|---|---|---|---|
| | (including dir) | dir(d) | strength (b) | length(c) |
| QCIF | 6(5) | 1 | 2 | 3 |
| QVGA | 7(6) | 1 | 2 | 3 (or 4) |
| CIF | 7(6) | 1 | 2 | 3 (or 4) |
| VGA | 8(7) | 1 | 2 | 4 |

Table 7 shows the number of bits of each field parameter according to the frame size. However, the present invention is not limited thereto, and the number of bits, besides the bits noted in Table 7, can be adjusted according to the characteristics of a bitstream.

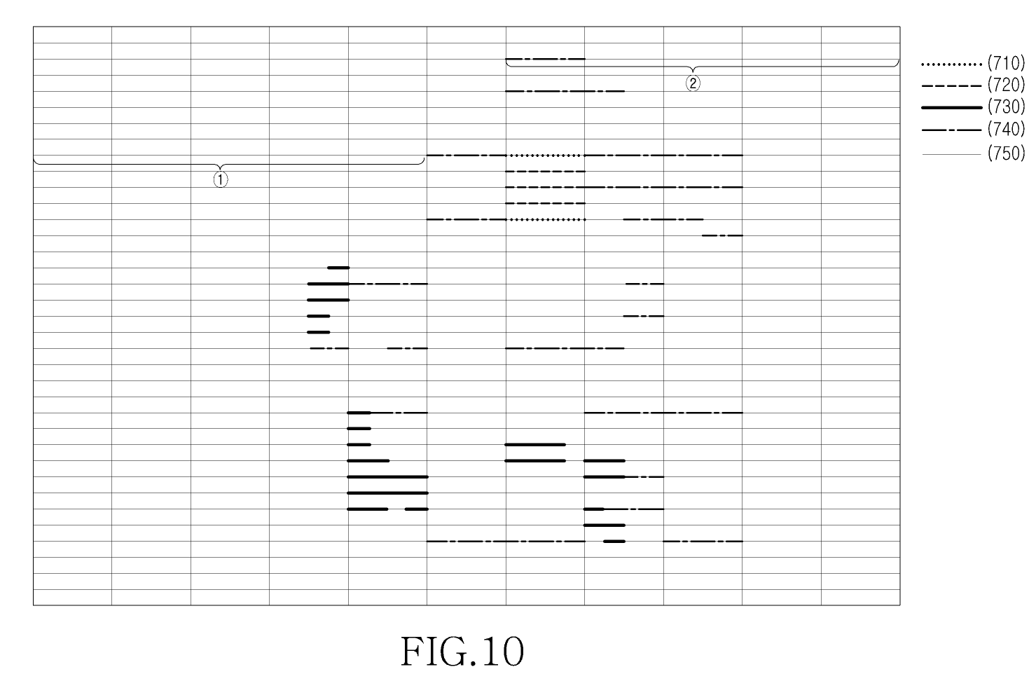

FIG. 10 illustrates an example of the packet as shown in FIG. 5, and exemplifies a packet structure not including a dir field. The packet as shown in FIG. 10 includes the cases where the BS is 0 (710), 1 (720), 2 (730), 3 (740), and 4 (750). When the BS is 0, 1 or 2, the movement of an interval of corresponding to an offset may convert information of all BSs into a compressed format.

As an example for expressing information of all BSs (BS=0˜2) of QCIF video as shown in FIG. 10 by minimum bits, the total number of bits may be represented by (11×4)×(9×4)×2, that is, 3168. In other words, when one macro block (or unit) includes 4 pixels (each pixel corresponds to each block in FIG. 10), one macro block includes 4 vertical BS information units, and 4 horizontal BS information units. Also, referring to Table 5, it can be seen that BS information includes 2 bits. Therefore, the total number of bits may be represented by (11×4)×(9×4)×2, that is, 3168, as described above.

If this is applied to a packet structure not including a dir field, according to the present invention, the following total 483 bits (75×5+21×6+36×2) are required, which corresponds to 15% (=(483/3168)×100) of the number of bits represented in a general way.

Table 8 is an example of a BS in a vertical direction as shown in FIG. 10.

TABLE 8

11
011000 01100 11
11
011000 01110 11
11
11
11
010100 01100 00110 01110 11
11
011100 01000 11
11
011100 01100 00110 01100 11
100010 01010 11
11
001111 10001 11
001110 10010 01100 00000 00010 01010 11
001110 10010 11
001110 10001 00000 00111 01010 11
001110 10001 11
001110 01010 00010 01010 00100 01110 11
11
11
11
010000 10001 01011 00000 01000 11
010000 10001 11
010000 10001 00111 10011 11
010000 10010 00110 10011 00001 10010 11
010000 10100 00000 10010 01010 11
010000 10100 11
010000 10010 00001 10001 00000 10001 01011
11
011100 10010 11
010100 01000 00001 10001 00010 01100 11
11
11
11
11

In the present invention, since BS information required for a deblocking filtering process of decoding is generated during the deblocking filtering of encoding and is provided as information on the BS, it is possible to omit the computation process required for computing an additional BS in the deblocking filtering process of the decoding.

In other words, the present invention is advantageous in that it can reduce computation processes and computational loads of a decoder because BS information required for the deblocking filtering processes of both encoding and decoding is shared. Therefore, through the present invention, it is possible to maintain the same amount of information even though the number of bits used is reduced.

Table 1 shows a packet size including BS information in the horizontal/vertical direction, according to the example as shown in FIG. 10, in comparison with actual computational loads.

TABLE 1

| | 0 | 1 | 2 | 3 | 4 | 5 | 6 | 7 | 8 | 9 | total |
|---|---|---|---|---|---|---|---|---|---|---|---|
| Bitstream | 1105 | 61080 | 3112 | 2536 | 2248 | 2648 | 2392 | 2344 | 2288 | 2552 | 32456 |
| size | | | | | | | | | | | |
| horizontal | 0 | 483 | 1350 | 1064 | 1100 | 1226 | 1099 | 1228 | 1021 | 1117 | 9688 |
| vertical | 0 | 470 | 1342 | 1174 | 1276 | 1290 | 1233 | 1303 | 1152 | 1193 | 10433 |

In Table 1, 0 to 9 at the top line indicate a frame constituting video, and “horizontal” and “vertical” at the left side indicate the directions of the BS.

Table 2 as shown below is for comparing and illustrating packet sizes including BS information according to Table 1 and FIG. 10.

TABLE 2

| | Filtering direction | total Seq. | total | remark |
|---|---|---|---|---|
| Prior art | BS in horizontal | 31680 | 63360 | 100% |
| | direction | | | |
| | BS in vertical | 31680 | | |
| | direction | | | |
| Present | BS in horizontal | 9688 | 20121 | 31.70% |
| invention | direction | | | |
| | BS in vertical | 10433 | | |
| | direction | | | |

Referring to Table 2, it can be seen that a coding method using a packet including BS information, according to the present invention, can reduce the number of bits to about 31.7%, compared to the related art.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for processing a boundary strength (BS) by a deblocking filter, the method comprising:
carrying out an encoding process for generating a packet comprising BS information; and
receiving the packet comprising the BS information, generated from the encoding process, and carrying out a decoding process by a decoding unit,
wherein the decoding process uses the BS information in deblocking.

2. The method as claimed in claim 1, wherein the encoding process generates a packet comprising an offset field, a BS field, a length field, and an end field.

3. The method as claimed in claim 1, wherein the encoding process generates a packet comprising an offset field, a dir field, a BS field, a length field, and an end field.

4. A coding apparatus comprising:
an encoding unit comprising: a deblocking filter which generates boundary strength (BS) information; and a packet encoder which generates a packet comprising the BS information generated from the deblocking filter; and
a decoding unit which decodes the packet generated from the encoding unit and applies the BS information to a deblocking process.

5. The coding apparatus as claimed in claim 4, wherein the decoding unit comprises;
a packet decoder which decodes the packet comprising the BS information, provided from the packet encoder; and
a deblocking filter which controls a block distortion of a bitstream provided from the encoding unit, based on the BS information decoded from the packet decoder.

6. The coding apparatus as claimed in claim 4, wherein the packet encoder rotates at least one unit of the packet in order to arrange a section of a maximum number of successive BSs of 0 to the last position of the packet.
